(19) United States
(12) Patent Application Publication
(10) Pub. No.: US 2012/0033239 A1
(43) Pub. Date: Feb. 9, 2012

(54) Mechanism for Inserting Information Into a Bitmap

(76) Inventor: John Thomas Varga, Longmont, CO (US)

(21) Appl. No.: 12/850,823

(22) Filed: Aug. 5, 2010

(51) Int. Cl. H04N 1/60

(52) U.S. Cl. 358/1.9

(57) ABSTRACT

A method is disclosed. The method includes receiving a print job, rasterizing the print job to produce rasterized bitmap data, retrieving additional information to be encoded into the bitmap data and compressing the bitmap data using the additional information by performing a sequence of optimal and sub-optimal compression.

### FIELD OF THE INVENTION

The invention relates to the field of printing systems, and in particular, to image compression in a printing system.

### BACKGROUND

Printers are common peripheral devices attached to computers. A printer allows a computer user to make a hard copy of documents that are created in a variety of applications and programs on a computer. To function properly, a channel of communication is established (e.g., via a network connection) between the printer and the computer to enable the printer to receive commands and information from the host computer.

Once a connection is established between a workstation and the printer, printing software is implemented at a print server to manage a print job from order entry and management through the complete printing process. As data is transmitted from the workstation it is rasterized at a processor so that image data is converted from a vector graphics format (e.g., shapes) into a raster image (e.g., picture elements (pels)) bitmap.

A bitmap typically includes random-looking data that provides no description of the data. Further, compression schemes used to compress the bitmap do not include additional information, other than the actual values to be presented. Thus, bitmaps are not checked for validity and potential hardware malfunctions (e.g., resulting from overheating, unfiltered electrical impulses, etc.), which may go undetected, resulting in unreliable data.

Therefore, a mechanism to insert additional information into a bitmap to ensure data validity is desired.

### SUMMARY

In one embodiment, a method is disclosed. The method includes receiving a print job, rasterizing the print job to produce rasterized bitmap data, retrieving additional information to be encoded into the bitmap data and compressing the bitmap data using the additional information by performing a sequence of optimal and sub-optimal compression.

Another embodiment discloses a print system including a print server to receive a print job and a printer. The printer includes a rasterizer to produce rasterized bitmap data, a compression module to compress the bitmap data by retrieving additional information to be encoded into the bitmap data and compressing the bitmap data using the additional information by performing a sequence of optimal and sub-optimal compression, a machine interface card (MIC) to receive the compressed data and a decompression module to decompress the data.

### BRIEF DESCRIPTION OF THE DRAWINGS

A better understanding of the present invention can be obtained from the following detailed description in conjunction with the following drawings, in which:

FIG. 1 illustrates one embodiment of a data processing system network;

FIG. 2 is a flow diagram illustrating one embodiment for compressing data;

FIG. 3A-3D are a flow diagram illustrating one embodiment for decompressing data; and

FIG. 4 illustrates one embodiment of a computer system.

### DETAILED DESCRIPTION

A mechanism for inserting additional information into a bitmap is described. In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

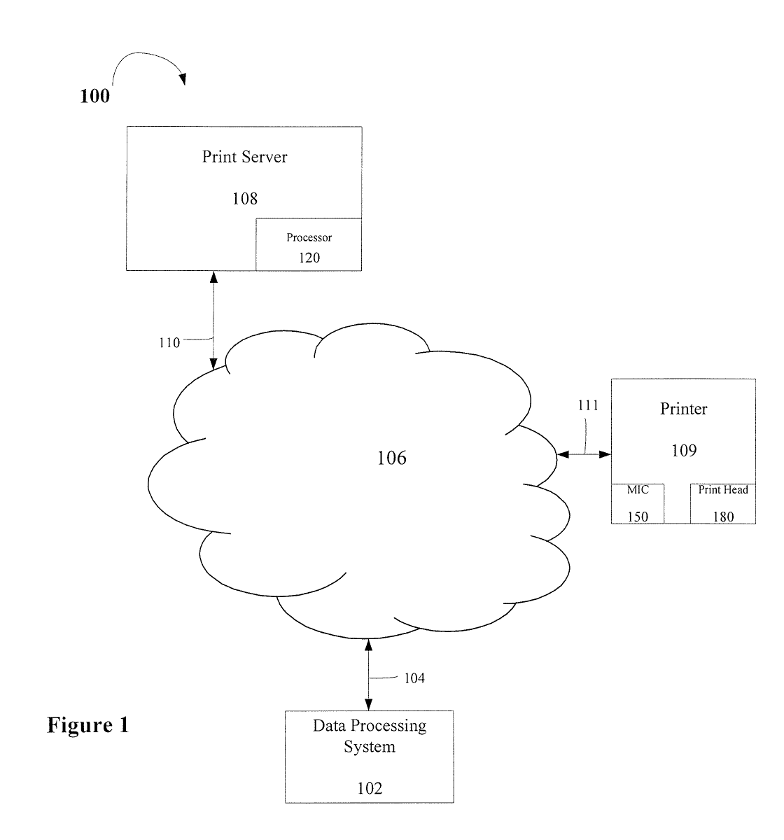

FIG. 1 illustrates one embodiment of a data processing system network 100. Network 100 includes a data processing system 102, which may be either a desktop or a mobile data processing system, coupled via communications link 104 to network 106. In one embodiment, data processing system 102 is a conventional data processing system including a processor, local memory, nonvolatile storage, and input/output devices such as a keyboard, mouse, trackball, and the like, all in accordance with the known art. In a further embodiment, data processing system 102 includes and employs the Windows operating system or a similar operating system and/or network drivers permitting data processing system 102 to communicate with network 106 for the purposes of employing resources within network 106.

Network 106 may be a local area network (LAN) or any other network over which print requests may be submitted to a remote printer or print server. Communications link 104 may be in the form of a network adapter, docking station, or the like, and supports communications between data processing system 102 and network 106 employing a network communications protocol such as Ethernet, the AS/400 Network, or the like.

According to one embodiment, network 106 includes a print server 108 that serves print requests over network 106 received via communications link 110 between print server 108 and network 106. Print server 108 subsequently transmits the print requests via communications link 110 to a printer 109 for printing, which is coupled to network 106 via communications link 111.

In one embodiment, the operating system on data processing system 102 allows a user to submit requests for service requests to printer 109 via print server 108 over network 106. In a further embodiment, print server 108 includes a print queue for print jobs requested by remote data processing systems.

Although described as separate entities, other embodiments may include print server 108 being incorporated into printer 109. Therefore, the data processing system network depicted in FIG. 1 is selected for the purposes of explaining and illustrating the present invention and is not intended to imply architectural limitations. Those skilled in the art will recognize that various additional components may be utilized in conjunction with the present invention.

According to one embodiment, print server 108 implements a printing software product that manages the printing of document data received from data processing system 102 at printer 109. Further, print server 108 includes a processor 120 that processes image objects received from data processing system 102 by performing a raster image process (RIP) to produce a bitmap having a multitude of pels.

Once the image is rasterized, the bitmap is transmitted to printer 109, where the data is stored at machine interface card (MIC) 150 before being printed at one or more print heads 180. As discussed above, the bitmap may include invalid data that has been attributed to hardware malfunctions. According to one embodiment, processor 120 inserts additional information during compression of the bitmap.

In such an embodiment, processor 120 implements a lossless compression scheme (e.g., PackBits) for run-length encoding of the bitmap data. PackBits compresses raw data by looking for repeated strings having the same 8-bit value. A control byte is used to indicate repeat (negative values) or pass-thru (positive values) data. The absolute value of the control byte is the number of repeated or passed-thru values decremented by 1. For instance, values 0 thru 127 indicate that 1 thru 128 passed-thru values will follow the control byte, while values −1 thru −127 indicate that the following value is repeated for a total of 2 thru 128 times. The value −128 is not defined, and thus may be used in non-standard ways.

In one embodiment, 3 or more identical 8-bit data values are coded as a repeat sequence (e.g., 0 0 0 raw 8-bit data is coded as −2 0). Further, a string of non-identical data values is coded as a pass-thru (or literal) string (e.g., 21 22 23 24 raw data is coded as 3 21 22 23 24). However, not all replications are advantageous. For example, 129 0 values followed by 21 22 may be coded as either 127 0 2 0 21 22, or −126 0 −1 0 1 21 22. Thus, the first compression uses 6 bytes, while the latter uses 7 bytes and is sub-optimal.

Also, making the 0s (too many for a single run) into two runs uses an extra byte in this case. Further, a repeated pair between two literal runs should not be a repeated value. For instance, the raw data 21 22 0 0 23 24 may be coded as 1 21 22 −1 0 1 23 24, but a byte is saved if the imbedded 0s are part of a literal, as in 5 21 22 0 0 23 24. Multiple repeated values like raw data 0 0 1 1 is best coded with repeats (−1 0 −1 1) rather than a literal (3 0 0 1 1, using an extra byte).

As shown above the compression scheme provides flexibility as to how data is compressed. According to one embodiment, processor 120 uses this flexibility to provide optimal and sub-optimal compressions on demand. In such an embodiment, processor 120 uses a combination of sub-optimal and optimal compression whenever additional data is to be inserted, where the choice of compression optimization is used to encode the additional data.

In one embodiment, various rules are implemented to enable optimal and sub-optimal compressions on demand. These rules include never using a single literal between repeat strings. Thus, at least one other value must be included. Another rule is that no literal string may have just one literal. For example, 0 23 for a single value of 23 is deemed sub-optimal. This allows a 1-valued literal to be used where there are no repeated values and thus no other way to differentiate sub-optimal from optimal compressions. Therefore, raw values of 0 0 0 23 45 45 45 45 is expressed as −2 0 1 23 45 −2 45 instead of −2 0 0 23 −3 45.

In a further embodiment, additional optimizations are performed whenever a literal reaches the maximum run (128 values) and a repeated value is encountered. Using the embedded 0 0 repeated values between 2 literals as an example, the 127<127 values>0 127 0<127 values> compresses the same as 126<127 values>−1 0 126<127 values> if the literals are 128 long. Since it is simplest for the compressor to have less rules, the embedded repeat of two 0 values may be treated as literal data without penalty, and is therefore preferred.

Moreover, providing optimal/sub-optimal compression results in a binary decision for each compression item (e.g., 1=optimal and 0 sub-optimal), which enables additional information to be deterministically recovered from the compressed data. In one embodiment, literal runs are to be at least 3 values long and repeat runs have a minimum of 3 repeated values. Each run may therefore be sub-optimized on demand so that a literal run becomes a literal run of 1 value followed by the literal run of the remainder (minimum of 2 values), and a repeat run can becomes a literal run of 1 value followed by a repeat run of the remainder (minimum of 2 values).

When decompressing, the following run is skipped for an encoded meaning if the run is a literal run of 1 (e.g., encoded bit=0). However, if the run is a repeat run or a literal run of more than 1 (e.g., encoded bit=1), the following run is not skipped). In other embodiments, different schemes may allow enhanced compression at the tradeoff of more algorithmic logic to encode and decode multiple alternate combinations.

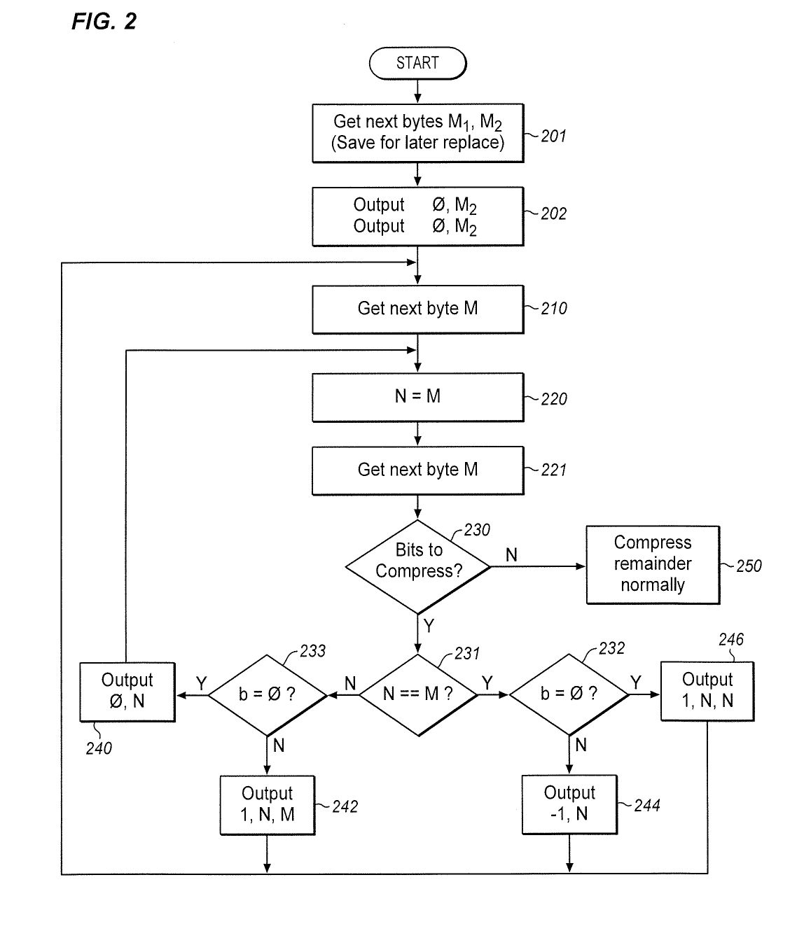

FIG. 2 is a flow diagram illustrating one embodiment for optimal/sub-optimal compression performed by processor 120. At processing block 201, the first two data bytes (e.g., M₁ and M₂) of the bitmap are retrieved. At processing block 202, the literal 0, M₂ is output twice. According to one embodiment, processing blocks 201 and 202 are used to flag the start of the bitmap for later decompression by forming a fixed pattern.

In such an embodiment, the pattern is not present in the data in any other way. In one embodiment, the pattern is presented by inserting a 0 or a 1 at every nth bit and having the top-of-bitmap value be a number n 0s or 1s in a row. Such a unique start pattern, coupled with the sub-optimal encodings, assures that the data combination is unique and would not be confused with starting from a random point in the bitmap.

As an example, the following sequence cannot occur in the above scheme: 0 M2 0 M2. This is a literal of length 1 with the value of M2 followed by another literal of length 1 with the same value of M2. The values themselves cannot occur within a literal string (e.g., they would have been a repeated string under best practices). The sequence is thus unique, but it does insert two M2 values at the start of the bitmap (for a 3rd party decoder) and does not leave the data completely unaltered.

In one embodiment, this may be followed by the sub-optimal compression to encode data back into the bitmap. Moreover, the first byte of encoded data may be the actual original data (M1) for the first values in the bitmap. This may be used to restore the final verified bitmap provided the decoder can perform the operations.

Referring back to FIG. 2, the next byte M is retrieved, processing block 210. At processing block 220, temporary placeholder (N) is set equal to byte M. At processing block 221, another byte M is retrieved. At decision block 230, it is determined whether a bit (b) of additional information to be included into the bitmap is available. If no bit is available, the remainder of the bitmap is compressed optimally, processing block 250.

If a bit is available, it is determined whether N equals M, decision block 231. If N equals M, it is determined whether b equals 0, decision block 232. If b does not equal 0, a repeat of two identical values (−1, N) is output, processing block 244. Subsequently, control is returned to processing block 210 where another byte M is retrieved. If b equals 0, a literal of two identical values (1, N, N) is output, processing block 246. Control is again returned to processing block 210.

If at processing block 231 N does not equal M, it is determined whether b equals 0, decision block 233. If b equals 0, a literal of one value (0, N) is output, processing block 240. Subsequently, control is returned to processing block 220 where N is again set equal to byte M. If b does not equal 0, a literal of two different values (1, N, M) is output, processing block 242. Control is again returned to processing block 210.

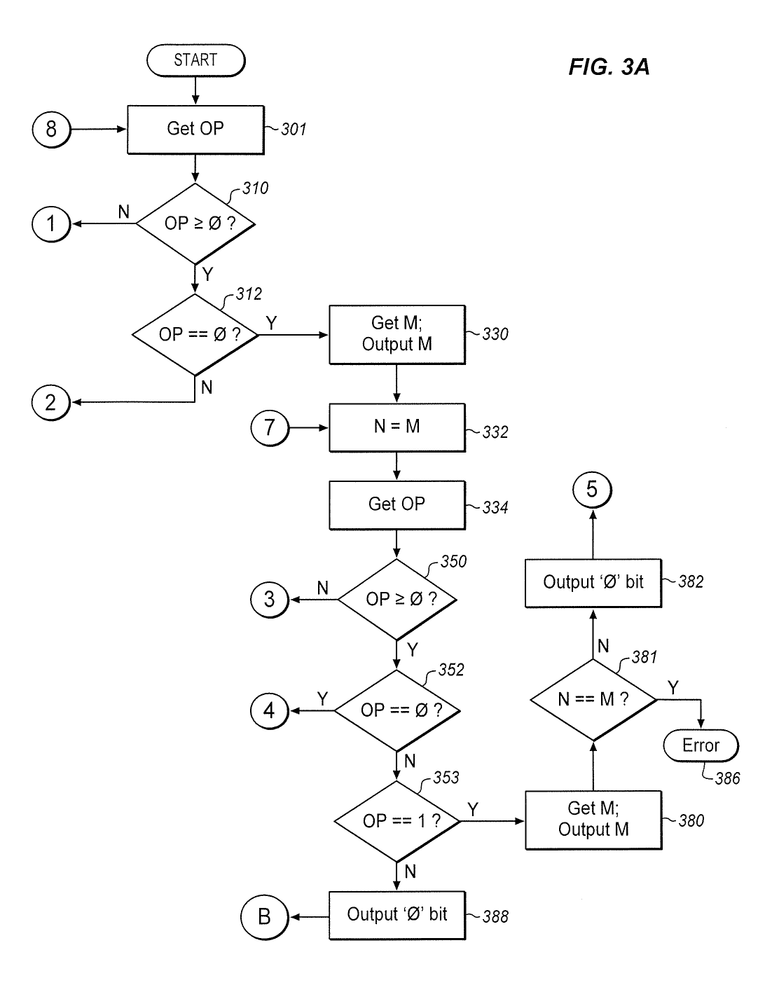

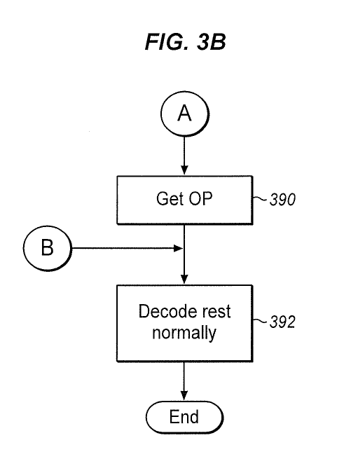

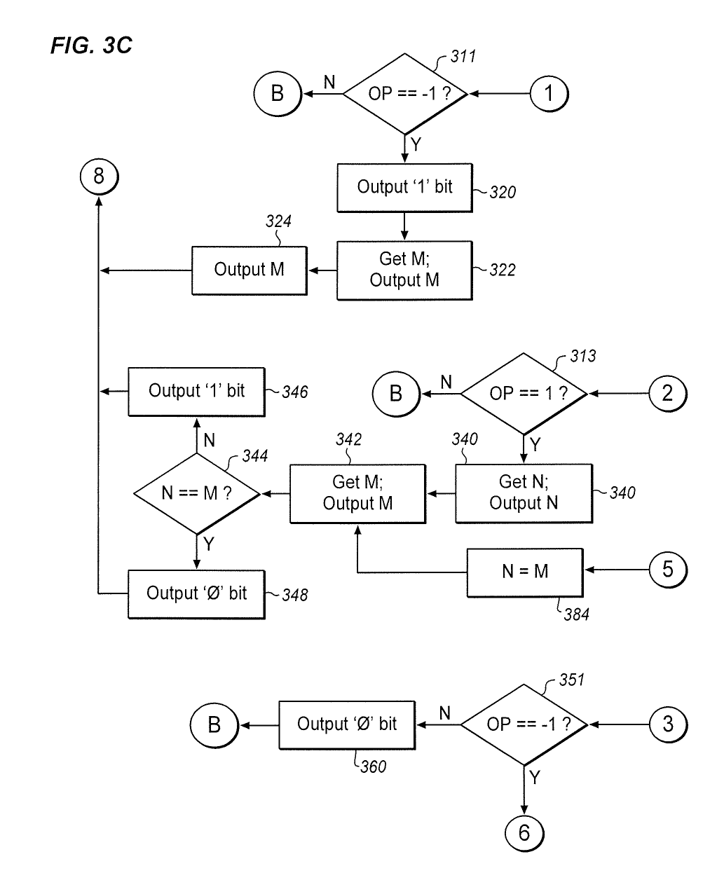

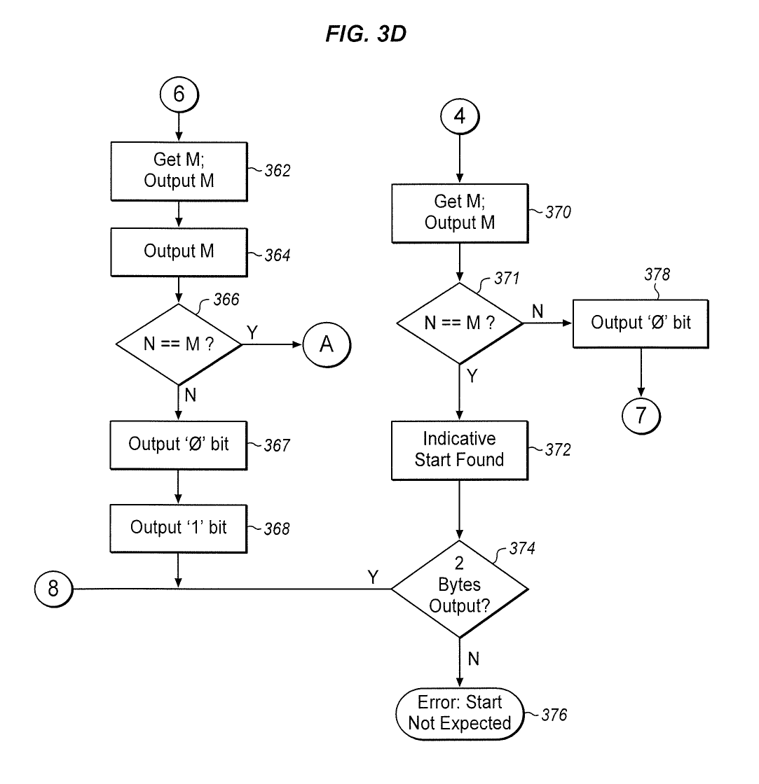

FIGS. 3A-3D is a flow diagram illustrating one embodiment for decompressing the received bitmap data. At processing block 301, an opcode byte (OP) is retrieved. At processing block 310, it is determined whether OP is greater than or equal to zero. If OP is greater than or equal to zero, it is determined whether OP equals zero, decision block 312. If OP equals zero, byte M is retrieved and output, processing block 330. At processing block 232, a temporary placeholder (N) is set equal to byte M.

At processing block 334, another opcode byte OP is retrieved. At decision block 350, it is determined whether OP is greater than or equal to zero. If OP is greater than or equal to zero, it is determined whether OP equals zero, decision block 352. If OP does not equal zero, it is determined whether OP equals 1, decision block 353.

If OP does not equal one, a zero bit is output, processing block 388. Thus, there are no more encoded bits in the bitmap, and the remainder of the bitmap is decompressed optimally beginning with OP, processing block 392 (see FIG. 3B). If OP equals one, the next byte M is retrieved and output, processing block 380. At decision block 381, it is determined whether N equals M. If so, an error has occurred because this sequence could not be encoded by the compressor.

If N does not equal M, a zero bit is output, processing block 382. At processing block 384, N is set equal to byte M (FIG. 3C). At processing block 342, a new byte M is retrieved and output. At processing block 344, it is determined whether N equals M. If not, a one bit is output and control is returned to processing block 301 (FIG. 3A) where another OP byte is retrieved. Otherwise, a zero bit is output before returning control to processing block 301.

At processing block 270 (FIG. 3D) another byte M is retrieved and output if OP equals zero at decision block 352. At decision block 371, it is again determined whether N equals M. If not, a zero bit is output and control is forwarded back to processing block 332 were N is set to equal M. Otherwise, an indication of the start of the bitmap is provided, processing block 372. At decision block 374, it is determined whether a total of exactly two bytes are output so far. If two bytes are not output, a start not expected error is provided. If two bytes are output, control is returned to processing block 301 (FIG. 3A) where another OP byte is retrieved.

If it is determined at decision block 350 that OP is less than zero, it is determined whether OP equals negative 1, decision block 351 (FIG. 3C). If OP does not equal negative one, a zero bit is output, processing block 360. Control is then forwarded to processing block 392 where the remainder of the bitmap is decompressed optimally beginning with OP (FIG. 3B).

If OP equals negative one, the next byte M is retrieved and output, processing block 362. At processing block 364, M is output again. At decision block 366, it is determined whether N equals M. If so, another opcode byte is retrieved processing block 390 (FIG. 3B). At processing block 392, the remainder of the bitmap is decompressed optimally. If at decision block 366 it is determined that N does not equal M, a zero bit is output, processing block 367. At processing block 368, a one bit is output. Control is then returned to processing block 301.

If at decision block 312 it is determined that OP does not equal zero, it is determined whether OP equals one (FIG. 3C). If OP equals one, N is retrieved and output, processing block 340 before passing control to processing block 342. Otherwise, control is forwarded to processing block 392 where the remainder of the bitmap is decompressed optimally (FIG. 3B).

If at decision block 310 it is determined that OP is less than zero, it is determined whether OP equals negative one, processing block 311 (FIG. 3C). If OP does not equal negative one, control is forwarded to processing block 392 where the remainder of the bitmap is decompressed optimally (FIG. 3B). If OP does equal negative one, a one bit is output, processing block 320. At processing block 322, a new byte M is retrieved and output. At processing block 324, M is output again. Control is then forwarded to control block 301 for retrieval of another opcode.

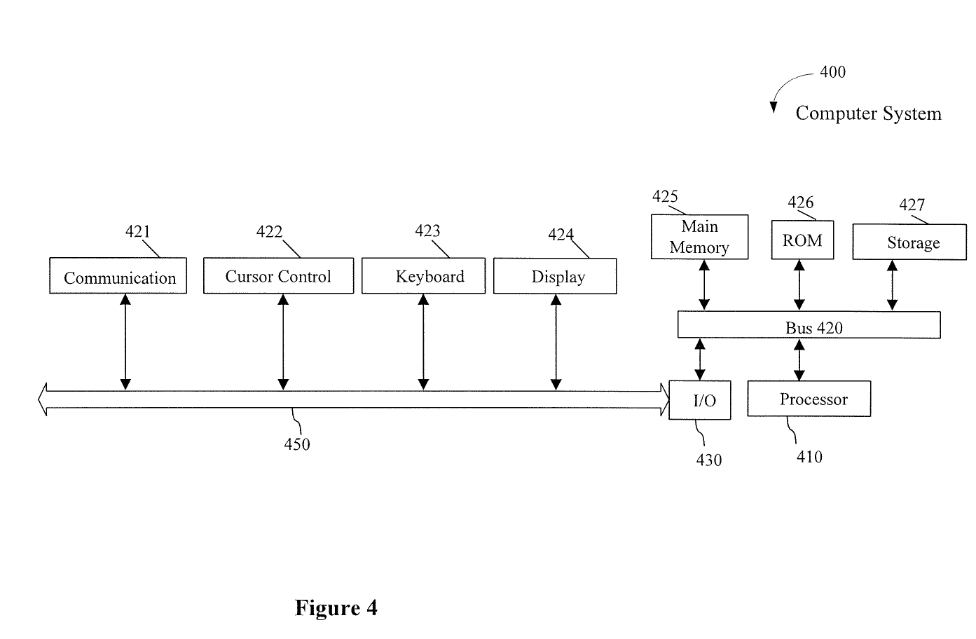

FIG. 4 illustrates a computer system 400 on which data processing system 102 and/or server 108 may be implemented. Computer system 400 includes a system bus 420 for communicating information, and a processor 410 coupled to bus 420 for processing information.

Computer system 400 further comprises a random access memory (RAM) or other dynamic storage device 425 (referred to herein as main memory), coupled to bus 420 for storing information and instructions to be executed by processor 410. Main memory 425 also may be used for storing temporary variables or other intermediate information during execution of instructions by processor 410. Computer system 400 also may include a read only memory (ROM) and or other static storage device 426 coupled to bus 420 for storing static information and instructions used by processor 410.

A data storage device 425 such as a magnetic disk or optical disc and its corresponding drive may also be coupled to computer system 400 for storing information and instructions. Computer system 400 can also be coupled to a second I/O bus 450 via an I/O interface 430. A plurality of I/O devices may be coupled to I/O bus 450, including a display device 424, an input device (e.g., an alphanumeric input device 423 and or a cursor control device 422). The communication device 421 is for accessing other computers (servers or clients). The communication device 421 may comprise a modem, a network interface card, or other well-known interface device, such as those used for coupling to Ethernet, token ring, or other types of networks.

Embodiments of the invention may include various steps as set forth above. The steps may be embodied in machine-executable instructions. The instructions can be used to cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as essential to the invention.

What is claimed is:

1. A method comprising:
receiving a print job;
rasterizing the print job to produce rasterized bitmap data;
retrieving additional information to be encoded into the bitmap data;
and
compressing the bitmap data using the additional information by performing a sequence of optimal and sub-optimal compression.

2. The method of claim 1 wherein performing sub-optimal compression comprises creating a literal run of only one value.

3. The method of claim 1 wherein performing sub-optimal compression comprises converting a repeat run of data into a literal run of two identical values.

4. The method of claim 1 further comprising decompressing the bitmap data.

5. The method of claim 4 wherein decompressing the bitmap data comprises determining if a run within the bitmap data is a literal run.

6. The method of claim 5 further comprising:
decoding the run as an optimal compression item if the run is not a literal run of one value or two identical values;

7. The method of claim 5 further comprising decoding the run as an optimal compression item if the run is a repeated run of two values.

8. The method of claim 1 further comprising inserting a pattern of bits into the bitmap data to identify the beginning of the bitmap data.

9. The method of claim 8 wherein the pattern comprises inserting two literal runs of the same value into the bitmap data to identify the beginning of the bitmap data.

10. A print system comprising:
a print server to receive a print job; and
a printer having:
a rasterizer to produce rasterized bitmap data;
a compression module to compress the bitmap data by retrieving additional information to be encoded into the bitmap data and compressing the bitmap data using the additional information by performing a sequence of optimal and sub-optimal compression;
a machine interface card (MIC) to receive the compressed data; and
a decompression module to decompress the bitmap data.

11. The print system of claim 10 wherein the compression module performing sub-optimal compression comprises creating a literal run of one value.

12. The print system of claim 10 wherein compression module performing sub-optimal compression comprises converting a repeat run of data into a literal run of two identical values.

13. The print system of claim 10 wherein the decompression module decompresses the bitmap data by determining if a run within the bitmap data is a literal run.

14. The print system of claim 13 wherein the decompression module further decompresses the bitmap data by decoding the run as an optimal compression item if the run is not a literal run of one or two identical values and including the following run as a component of the bitmap data.

15. The print system of claim 13 wherein the decompression module decodes the run as an optimal compression item if the run is a repeated run of two values.

16. An article of manufacture comprising a machine-readable medium including data that, when accessed by a machine, cause the machine to perform operations comprising:
receiving a print job;
rasterizing the print job to produce rasterized bitmap data;
retrieving additional information to be encoded into the bitmap data; and
compressing the bitmap data using the additional information by performing a sequence of optimal and sub-optimal compression.

17. The article of manufacture of claim 16 wherein performing sub-optimal compression comprises converting a repeat run of data into a literal run of one value followed by a repeat run of the remaining values.

18. The article of manufacture of claim 1 comprising a machine-readable medium including data that, when accessed by a machine, cause the machine to further perform operations comprising decompressing the bitmap data.

19. The article of manufacture of claim 18 wherein decompressing the bitmap data comprises determining if a run within the bitmap data is a literal run.
